(19) United States
(12) Patent Application Publication
(10) Pub. No.: US 2026/0245046 A1
(43) Pub. Date: Aug. 20, 2026

(54) INFORMATION PROCESSING DEVICE, INFORMATION PROCESSING SYSTEM, INFORMATION PROCESSING METHOD, AND INFORMATION PROCESSING PROGRAM

(71) Applicant: KITZ CORPORATION, Tokyo (JP)

(72) Inventors: Isao NISHIZAWA, Chiba (JP); Motohiro FURUYA, Chiba (JP); Yuu INOUE, Chiba (JP)

(21) Appl. No.: 18/858,901

(22) PCT Filed: Apr. 26, 2023
(86) PCT No.: PCT/JP2023/016464

§ 371 Date: Oct. 22, 2024

(30) Foreign Application Priority Data
Apr. 28, 2022 (JP) 2022-075326

(51) Int. Cl. G06Q 10/20; G05B 23/02

(52) U.S. Cl. CPC G06Q 10/20; G05B 23/0283

(57) ABSTRACT

Provided is a technique capable of predicting a recommended replacement time of each of a plurality of elements in valve and outsourcing work to an appropriate maintenance provider in a short period of time. An information processing device (100): acquires abnormality detection information related to each of the plurality of elements in valves (V1 to V4); generates presentation information for presenting, to a customer, maintenance providers selected based on the information; and provides, to the selected maintenance providers, maintenance-related information pertaining to one of the plurality of elements in which an abnormality is detected.

### TECHNICAL FIELD

The present invention relates to an information processing device, an information processing system (maintenance outsourcing system), an information processing method, and an information processing program.

### BACKGROUND ART

Generally, in various locations including large-scale facilities such as various plants and buildings, or small-scale structures such as houses and shops, various pipeline equipment is provided. Such pipeline equipment includes, for example, various pipes, valves, and various actuators for automatically controlling these valves. Among rotary valves, such as ball valves or butterfly valves, used in this pipeline equipment, 90-degree rotation type (quarter-turn type) rotary valves are in high demand. Further, as actuators for driving these, pneumatic actuators, for example, are often installed.

Typically, in order to automatically control devices such as the valves and the actuators or to manage and maintain operating conditions thereof, such pipeline equipment also requires a device that monitors the state of these devices. In recent years, there also has been a growing demand for not only state monitoring of the valves and the actuators in pipeline equipment, but also more precise state detection capabilities and systems capable of managing and controlling these devices from various perspectives based on the detection results thereof. Examples of the state detection capabilities include failure prediction and service life diagnosis of the devices described above, and appropriate evaluation and differentiation for each failure and symptom at a product and component level.

For example, Patent Document 1 discloses a technique of identifying a state of a valve by a sensor unit including a gyro sensor attached to an output shaft of the valve. This technique targets rotary valves such as ball valves or butterfly valves and is a technique of measuring angular velocity data associated with rotation of the entire rotation region of the valve from a fully closed state to a fully open state of the valve during operation of the valve. The measured angular velocity data is compared with reference data stored in advance in the system, the reference data being angular velocity data from an initial (new) state to a failed state of the valve. By this comparison of the measured angular velocity data with the reference data, the valve state, which is not ascertainable from an outer appearance of the valve, is identified. Then, the number of times (time period) the valve can be subsequently operated before failure is identified by abnormalities that occur prior to valve failure. Examples of these abnormalities include a change in the transition of the angular velocity data, a position of a peak, a peak width, and a peak magnitude.

Further, a valve state identification system is known that facilitates highly accurate abnormality detection or state prediction based on efficient valve system monitoring and information accumulation (for example, refer to Patent Document 2). This system acquires information pertaining to a position and an operation history of a valve in a line and predicts the state of the valve with reference thereto. Further, the acquired information is accumulated and utilized for further prediction of the state of the valve.

### CITATION LIST

### Patent Literature

Patent Document 1: WO 2019/235599.

Patent Document 2: WO 2021/117810.

### SUMMARY OF INVENTION

### Technical Problem

According to the abnormality prediction technique described above, it is possible to avoid a situation in which failure occurs, causing a production line to stop and an operation rate of the plant to decrease. However, a technical approach for minimizing the time required from valve abnormality prediction to maintenance completion is nonexistent. If a customer does not have a relationship with a specific maintenance provider, the customer needs to choose a new provider when considering repair or replacement of the target valve. Choosing a maintenance provider from scratch in this way is time-consuming for the customer.

On the other hand, there are now individual maintenance providers that specialize in the maintenance of different kinds of valves (valve types), actuators that operate the valves, and the like, by product or by component. If the customer does not have a relationship with a specific maintenance provider, the customer has no choice but to choose a new maintenance provider. Further, setting up the maintenance time and the like after choosing a maintenance provider also requires ongoing coordination and pre-arrangements between the customer and the provider. Thus, the management burden on the customer increases. This is because, even if automation (artificial intelligence (AI)) is used for abnormality prediction, the maintenance itself is a human task and a rational man-machine interface does not exist.

Further, even in a case in which a business relationship exists between a particular maintenance provider and a customer, the maintenance schedule may be delayed due to the busy schedule of the maintenance provider, scheduled repairs, or various other circumstances related to maintenance, adversely affecting plant operations. Such circumstances include, for example, a valve being installed in a hazardous location, such as in an explosion-proof structure or in a high-voltage facility, requiring special maintenance work.

In view of the circumstances described above, it is an object of an aspect of the present invention to provide an information processing device capable of predicting a recommended replacement time of each of a plurality of elements in a valve and outsourcing the work to an appropriate maintenance provider that matches the maintenance work content in a short period of time.

### Solution to Problem

To solve the problems described above, an information processing device according to an aspect of the present invention includes: an abnormality detection information acquisition unit configured to acquire abnormality detection information including abnormality detection data related to each of a plurality of elements in a valve; a presentation information generation unit configured to generate presentation information for presenting, to a customer being a user of the valve, maintenance providers selected in accordance with one of the plurality of elements in which an abnormality is detected based on the abnormality detection information and information pertaining to a time related to the abnormality; and a maintenance-related information provision unit configured to provide, to the selected maintenance providers, maintenance-related information related to the one of the plurality of elements in which the abnormality is detected and the information pertaining to the time related to the abnormality.

To solve the problems described above, an information processing system according to an aspect of the present invention includes: an abnormality detection information acquisition unit configured to acquire abnormality detection information including abnormality detection data related to each of a plurality of elements in a valve; a presentation unit configured to present presentation information for presenting, to a customer being a user of the valve, maintenance providers selected in accordance with one of the plurality of elements in which an abnormality is detected and a time; and a maintenance-related information provision unit configured to provide, to the selected maintenance providers, maintenance-related information pertaining to the one of the plurality of elements in which the abnormality is detected and the time concerning the one of the plurality of elements in which the abnormality is detected.

To solve the problems described above, an information processing method according to an aspect of the present invention is an information processing method for supporting maintenance of a valve by generating information pertaining to the maintenance of the valve with reference to a signal configured to detect operation of the valve. The information processing method includes: acquiring abnormality detection information including abnormality detection data related to each of a plurality of elements in the valve; generating presentation information for presenting, to a customer being a user of the valve, maintenance providers selected in accordance with one of the plurality of elements in which an abnormality is detected based on the abnormality detection information and information pertaining to a time related to the abnormality; and providing, to the selected maintenance providers, maintenance-related information related to the one of the plurality of elements in which the abnormality is detected and the information pertaining to the time related to the abnormality.

### Advantageous Effects of Invention

According to an aspect of the present invention, it is possible to provide an information processing device that, in a case in which an abnormality is detected in each of a plurality of elements of a valve, is capable of predicting a recommended replacement time of each element and outsourcing service to an appropriate maintenance provider matching the maintenance work content in a short period of time.

### BRIEF DESCRIPTION OF DRAWINGS

FIG. 1 is a diagram illustrating a configuration of an information processing system (maintenance outsourcing system) according to an embodiment of the present invention.

FIG. 2 is a flowchart illustrating a processing flow of the information processing system according to an embodiment of the present invention.

FIG. 3 is a sequence diagram illustrating an information flow in the information processing system according to an embodiment of the present invention.

FIG. 4 is a diagram illustrating an example of a graph of angular velocity data used in the information processing system according to an embodiment of the present invention.

FIG. 5 is a perspective view of a valve unit included in the information processing system according to an embodiment of the present invention.

FIG. 6 is an example of a display screen of a user terminal device included in the information processing system according to an embodiment of the present invention.

FIG. 7 is an example of a display screen of a maintenance provider terminal device included in the information processing system according to an embodiment of the present invention.

FIG. 8 is a block diagram illustrating a physical configuration of each device constituting the information processing system according to an embodiment of the present invention.

FIG. 9 is a flowchart illustrating a main portion of a processing flow of the information processing system according to another embodiment of the present invention.

FIG. 10 is a sequence diagram illustrating an information flow in a case in which emergency maintenance is performed in the information processing system according to another embodiment of the present invention.

### DESCRIPTION OF EMBODIMENTS

In an embodiment of the present invention, an abnormality is detected from angular velocity data of a rotation of a rotation shaft in a valve unit in which an actuator rotates the rotation shaft to rotate a disc or ball of a valve. Furthermore, an information processing device is realized that is capable of estimating a time of maintenance from this angular velocity data, selecting an appropriate maintenance provider that matches the maintenance work content, and notifying the user accordingly.

### First Embodiment

Hereinafter, an embodiment of the present invention will be described in detail with reference to the drawings.

### Information Processing System (Maintenance Outsourcing System) 500

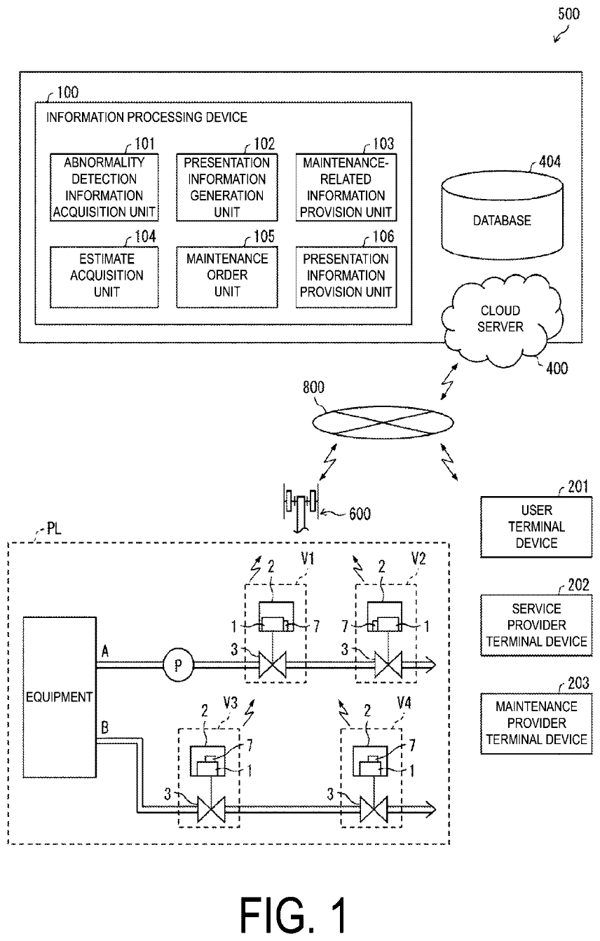

FIG. 1 is a diagram schematically illustrating a configuration of an information processing system (also called “maintenance outsourcing system”) 500 according to the present embodiment. First, a configuration of the information processing system 500 will be described with reference to FIG. 1.

The information processing system 500 includes pipeline equipment PL, a gateway 600 capable of wirelessly communicating with respective sensor units 1 of valve units V1, V2, V3, V4 included in the pipeline equipment PL, a server 400 communicably connected to the gateway 600 via a network (Internet 800) communicably connected to the gateway 600, and terminal devices 201, 202, 203. The terminal devices 201, 202, 203 are a user terminal device, a service provider (administrator of the information processing system 500) terminal device, and a maintenance provider terminal device, respectively.

Here, the server 400 may be a cloud server and stores an information processing device 100, a database 404, and the like. The server 400 has a communication function based on a middle-range wireless communication module such as long-term evolution (LTE) or Wi-Fi (trade name) as a transmission/reception function with the gateway 600.

As illustrated in FIG. 1, the pipeline equipment PL includes a device used for a heat source, chemical refining, water purification, or purification, for example, piping systems A, B connected to this device, the valve units V1, V2, V3, V4 provided to the piping systems A, B, and a pump P. Each of the valve units V1 to V4 includes a valve 3, an actuator 2 that drives the valve 3, and the sensor unit 1. The sensor unit 1 includes a gyro sensor 7. Details of the pipeline equipment PL will be described below.

The information processing system 500 includes the information processing device 100, making it possible to monitor and control the pipeline equipment PL and, in a case in which an abnormality is detected, outsource the work to a maintenance provider at an appropriate time.

Hereinafter, the information processing device 100 will be described.

### Configuration of Information Processing Device 100

An abnormality detection information acquisition unit 101 functions as an acquisition unit and an estimation unit. The acquisition unit acquires, in a valve unit in which an actuator rotates a rotation shaft to rotate a disc or ball of a valve, angular velocity data of the rotation of the rotation shaft, the angular velocity data being detected by an angular velocity sensor. The estimation unit estimates a degree of abnormality of each of the actuator and the valve with reference to the angular velocity data acquired by the acquisition unit.

The information processing device 100 is responsible for monitoring or controlling the valve 3 and the actuator 2 of the pipeline equipment PL to maintain and control the valve units V1 to V4. Furthermore, in a case in which an abnormality is detected in the valve 3 or the actuator 2, the information processing device 100 is responsible for outsourcing the maintenance to a provider at an appropriate time. Therefore, as illustrated in FIG. 1, the information processing device 100 includes the abnormality detection information acquisition unit 101, a presentation information generation unit 102, a maintenance-related information provision unit 103, an estimate acquisition unit 104, a maintenance order unit 105, and a presentation information provision unit 106. Hereinafter, each component will be described.

### Abnormality Detection Information Acquisition Unit 101

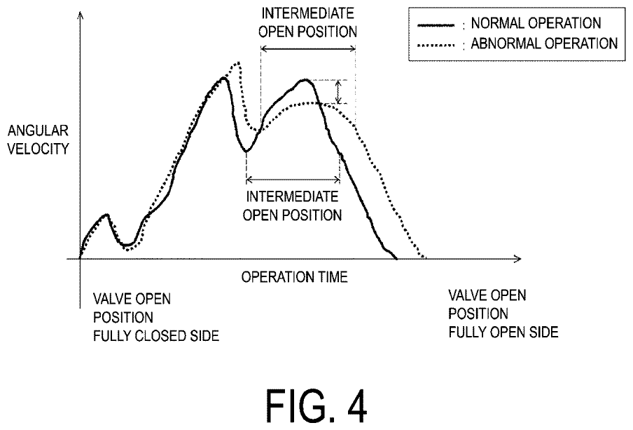

The abnormality detection information acquisition unit 101 acquires abnormality detection information including abnormality detection data related to each of a plurality of elements in a valve. For example, the abnormality detection information may be output information of an angular velocity sensor configured to detect angular velocity data of the rotation of a rotation shaft in a valve unit in which an actuator rotates the rotation shaft to rotate a disc or ball of a valve. More specifically, given that the data is the operation time and the angular velocity illustrated in FIG. 4, the abnormality detection information is data indicating a numerical value of the angular velocity at a certain operation time of the valve, the numerical value deviating from a numerical value of an angular velocity during normal operation at that operation time. The abnormality detection information acquisition unit 101 acquires, from each sensor unit 1, output information (angular velocity data) of the gyro sensor 7 of the sensor unit 1 via the gateway 600 and the server 400. The angular velocity data is stored in the database 404 via the server 400.

The abnormality detection information acquisition unit 101, with reference to the angular velocity data acquired from the gyro sensor 7, estimates a type of abnormality and a degree of abnormality for each of the plurality of elements in the valve, that is, each of the actuator 2, the valve 3, and the like. A method for estimating the type of abnormality and the degree of abnormality will be described below with reference to FIG. 4.

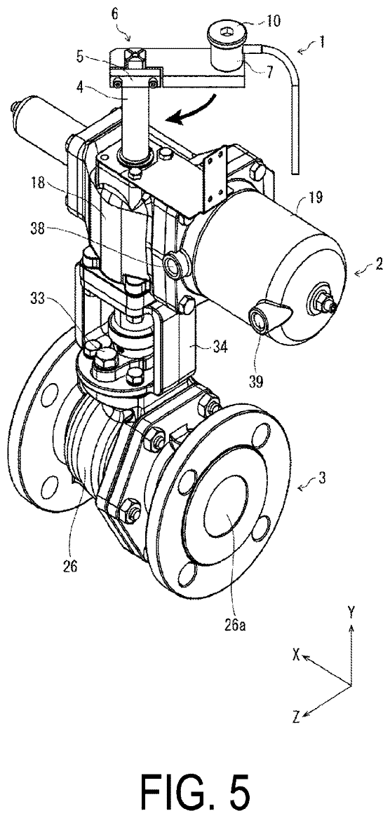

The “rotation shaft” described above is a general term for a shaft that transmits power for rotating a disc or ball of the valve 3. The “rotation shaft” refers to one or more of a stem coupled to the disc or ball of the valve 3 of each of the valve units V1 to V4, an output shaft of the actuator 2 coupled to the stem, and a control shaft 4 (FIG. 5) of the actuator 2. Configurations of the sensor unit 1, the actuator 2, and the valve 3 included in each of the valve units V1 to V4 will be described below with reference to FIG. 5.

The abnormality detection information acquisition unit 101 may acquire the value of the angular velocity detected by the gyro sensor 7 as the angular velocity data, or may acquire angular velocity data (angular velocity graph) obtained by transitioning and graphing the measured value of the angular velocity in accordance with a valve open position on the sensor unit 1 side.

The present inventors discovered that a decrease in performance of the valve 3 due to, for example, wear or chipping of a ball seat and a decrease in performance of the actuator 2 are largely related to a change in angular velocity with respect to the valve open position over time. This led to the present inventors finding that the degree of abnormality of each of the actuator 2 and the valve 3 can be estimated by primarily measuring the change in the angular velocity with respect to the valve open position over time by the gyro sensor 7 of the sensor unit 1 and diagnosing the change.

Thus, the abnormality detection information estimation unit 101 estimates the degree of abnormality of each of the actuator 2 and the valve 3 based on a value of the angular velocity data corresponding to the open position of the valve 3.

Specifically, in the case of an aspect in which the actuator 2 is a pneumatic rotary actuator having a double-acting scotch yoke structure and the rotation shaft of the valve is rotated by this scotch yoke pneumatic actuator, the present inventors discovered the following items. That is, the present inventors discovered that, in this case, when the scotch yoke has deteriorated, an output torque is weakened when the valve is at an intermediate open position, and a change is observed in the transition of the angular velocity data at the intermediate open position. That is, when the scotch yoke has deteriorated, the transition of the angular velocity data when the valve is at an intermediate open position changes (decreases) as compared with an actuator without scotch yoke deterioration. Similarly, in the case of a rack-and-pinion actuator, there is a change (decrease) in the transition of the angular velocity data when the valve is at an intermediate open position due to the deterioration.

Furthermore, the present inventors noted that, in a case in which the valve 3 is a sliding valve that opens and closes while sliding, such as a ball valve and a butterfly valve, particularly in the case of the ball valve, a contact area between the ball and the ball seat at an intermediate open position of the valve 3 decreases (that is, a sliding frictional force decreases). In other words, it was considered unlikely that the ball valve would affect the transition of the angular velocity data at an intermediate open position. That is, the present inventors discovered that, when a rapid change (decrease) is observed in the transition of the angular velocity data at an intermediate open position of the valve 3, it can be determined (estimated) that an operation abnormality of the scotch yoke actuator has occurred.

Thus, the abnormality detection information estimation unit 101 estimates the degree of abnormality of the actuator 2 based on the numerical value of the angular velocity data in the rotation of the rotation shaft other than the rotation during the initial stage and the final stage (at an intermediate open position of the valve).

The present inventors noted that when the pipeline equipment PL illustrated in FIG. 1 is installed outdoors, there are cases in which the actuator 2 is affected by the external environment and fails. Specifically, the present inventors found that an output torque of the actuator 2 decreases when the actuator itself has deteriorated due to the effects of rainwater and the like.

Then, the present inventors found that, in the “transition of the angular velocity at an intermediate open position of the valve operated by the deteriorated actuator,” the value of the angular velocity overall falls lower than in the “transition of the angular velocity at an intermediate open position of the valve operated by a normal actuator.”

In the case of a pneumatic actuator, for example, air is supplied. An interior of the actuator is sometimes corroded by moisture contained in the air supplied thereto or by moisture caused by condensation due to a temperature difference between the air having a relatively high temperature supplied into the actuator and the atmosphere inside the actuator, or the like. Among these, in the case of the supplied air containing moisture, corrosion sometimes occurs on a surface of an inner wall portion of a cylinder or a surface of a piston where the supplied air stagnates. When rust occurs on the surface of the inner wall portion and the surface of the piston due to this corrosion, these surfaces become rough due to the rust.

Therefore, in a case in which the actuator is rusted by corrosion, a sliding resistance applied between the piston and the inner wall of the actuator increases when the piston slides on the inner wall portion as the actuator operates. At this time, the pressure itself of the supplied air, which is the output torque of the actuator, does not change. Therefore, the value of the angular velocity, which is the open/close velocity of the valve, decreases. Thus, by detecting such a change in the transition of the angular velocity, it is possible to identify the deteriorated state caused by rust in the interior of the pneumatic actuator.

In addition, in the case of a spring return actuator capable of returning to an original starting position by an elastic deformation action of an internal spring, an elastic deformation force is reduced when the spring is corroded. Further, for example, as the rust comes off the spring, a diameter of the spring is reduced (diameter is narrowed). In such a case, the stress from the spring may not be transmitted to the piston or the spring may break, and the opened/closed valve may not return to its origin.

As described above, when the valve is at an intermediate open position, there is substantially no contact between the ball and the ball seat, making it unlikely that the valve will affect the transition of the angular velocity data at an intermediate angle. Therefore, when an overall change (decrease) is observed in the transition of the angular velocity data when the valve is at an intermediate open position, it can be determined (estimated) that the actuator has deteriorated.

On the other hand, during a period other than when the valve is at an intermediate open position, that is, a period when the valve starts the open operation from a fully closed state and a time when the valve starts the close operation from a fully open state (initial stage of rotation of ball), the contact area between the ball and the ball seat increases (that is, the sliding frictional force increases). Similarly, during the periods immediately before the valve is fully closed and immediately before the valve is fully open (end stage of rotation of the ball), the ball and the ball seat are in contact with each other. That is, during these periods, the state of the valve, particularly the ball seat, is represented as angular velocity data via the rotation shaft.

Thus, the abnormality detection information acquisition unit 101 estimates the degree of abnormality of the valve 3 based on the numerical value of the angular velocity data in the initial stage of rotation and the end stage of rotation of the rotation shaft.

That is, in the present embodiment, the degrees of abnormality of both the actuator 2 and the valve 3 are estimated by the abnormality detection information acquisition unit 101 based on the transition of the angular velocity data from the initial stage of rotation, through an intermediate stage of rotation, and to the end stage of rotation of the rotation shaft.

Herein, an “abnormality” of the valve refers to foreign matter intrusion into the ball seat; ball seat swelling; ball seat wear; packing wear; wear of a gland portion of the body; gland packing wear; stem bearing wear; stem galling; foreign matter adhesion, accumulation, or scratches on the ball surface; and the like, as described below. An “abnormality” of the actuator refers to an increase in sliding resistance of the actuator (including an increase in sliding resistance due to rust or corrosion caused by moisture entering the actuator), failure due to the freezing of moisture in the actuator, a decrease in pressure supplied to the actuator, and the like, as described below.

The abnormality detection information acquisition unit 101 compares the angular velocity data acquired from the sensor unit 1 with reference data that is comparative angular velocity data (for example, reference data of comparative angular velocity data serving as a reference for estimating the degree of abnormality) across the entire range of the valve open positions (the valve open positions between 0° and 90°). However, the comparison is not limited thereto, and may be performed within a specific valve open position range that is a portion of the entire range. An example of a specific valve open position range is a valve intermediate open position. As described above, by comparing actually measured angular velocity data with the reference data at an intermediate open position of the valve 3, it is possible to estimate the degree of abnormality with a focus on the actuator 2. As another example of a specific valve open position range, an initial open position, a final open position, or the respective periods before the initial open position may be used.

The reference data may be stored in the database 404, and the abnormality detection information acquisition unit 101 may acquire the reference data from the database 404. As described below, the reference data may be stored in advance or may be data obtained by accumulating past angular velocity data detected by the gyro sensor 7.

Further, the abnormality detection information acquisition unit 101, with reference to the reference data, estimates the degree of abnormality by comparing the angular velocity data acquired by the abnormality detection information acquisition unit 101 with the reference data. The reference data can be acquired by, for example, detecting the rotation of the rotation shaft of a normal valve by the gyro sensor 7.

An example in which the abnormality detection information acquisition unit 101 estimates the type of abnormality of an element in the valve by comparing the angular velocity data acquired from the gyro sensor 7 with the reference data will be described below with reference to FIG. 4.

Here, the gyro sensor 7 of the sensor unit 1 is preferably attached to the control shaft 4 (FIG. 5) or the output shaft of the actuator 2. This is because, although a time lag occurs between the time when the actuator 2 starts driving and the time when the valve 3 starts rotating, angular velocity data based on the driving of the actuator 2 during this time lag can be acquired. The time lag is caused by backlash of a drive system reduction gear inside the actuator 2 and play (looseness) in a connection portion between the output shaft of the actuator 2 and the stem of the valve 3. Accordingly, when the gyro sensor 7 is attached not to the valve 3 side but to the actuator 2 side, the angular velocity can be detected simultaneously with the start of the driving by the actuator 2, making it possible to detect the angular velocity more precisely. In particular, in a valve in which normal and reverse rotations are repeated, it is possible to detect the degree of deterioration of the gear from an expansion of a gap between the backlash and the play by reliably utilizing the backlash and the play portion described above at the time of initial operation, which is effective.

Furthermore, the abnormality detection information acquisition unit 101 makes predictions related to the “time of abnormality” based on the above-described estimated degree of abnormality of each element in the valve and acquires information pertaining to the “time of abnormality.” Here, the information pertaining to the time related to the abnormality acquired by the abnormality detection information acquisition unit 101 may include information pertaining to a recommended replacement time of the element detected as having an abnormality.

More specifically, the abnormality detection information includes, for example, a name or a model number of a component of a valve or an actuator that requires replacement, data of a product name or a model number of the valve in a case in which the valve itself is to be replaced, and a list of rival valve or actuator products of other companies that satisfy the same specifications. As a result, the user can find out the approximate replacement time of an element (component) before failure occurs in the element, and thus arrange for maintenance at an appropriate time.

Further, the information pertaining to the recommended replacement time is, for example, information pertaining to an amount of time until the recommended replacement time. More specifically, in the case of a valve, if the expected time to failure due to wear of a sealing member of a ball valve detected as having an abnormality is “after 9 months” and the recommended replacement time is “after 6 months” based on information such as concurrence with other maintenance, the recommended replacement time in this case may be “6 months.” Further, in the case of an actuator, if the expected time to failure due to wear of a sliding gear component in the actuator of a ball valve detected as having an abnormality is “after 12 months” and the recommended replacement time is “after 8 months,” the recommended replacement time in this case may be “8 months.”

Further, the information pertaining to the time related to the abnormality described above may include information pertaining to a recommended replacement time of the element detected as having the abnormality, this information being selected based on information pertaining to recommended replacement times of all valves owned by the customer (user) in the same region. For example, the information pertaining to the time related to the abnormality may include information pertaining to recommended replacement times of all elements included in the valve units V1 to V4 illustrated in FIG. 1. As a result, the user can identify the recommended replacement times for all elements included in the valve units owned by the user in the same region, and can collectively arrange maintenance for all elements at an appropriate time. Note that the selection processing described above may be configured to be performed by, for example, the abnormality detection information acquisition unit 101.

Further, the information pertaining to the time related to the abnormality may include information pertaining to a recommended replacement time of the element detected as having the abnormality, this information being selected based on information pertaining to a time of periodic inspection of the valves owned by the customer in the same region or operation information of the customer. For example, in a case in which the user outsources maintenance to a specific maintenance provider to perform periodic inspections of the equipment, the specific maintenance provider and the user can coordinate the timing of the periodic inspections, the operation information of the customer, and the recommended replacement times of the elements. Then, as a result, maintenance scheduling can be performed. Note that the selection processing described above may be performed by, for example, the abnormality detection information acquisition unit 101.

The abnormality detection information acquisition unit 101 transmits the element detected as having an abnormality and the information pertaining to the time related to the abnormality to the presentation information generation unit 102.

### Presentation Information Generation Unit 102 and Presentation Information Provision Unit 106

The presentation information generation unit 102 generates presentation information for presenting, to a customer being a user of the valve, a maintenance provider selected in accordance with an element detected as having an abnormality and information pertaining to a time related to the abnormality, the element and the information being based on the abnormality detection information. For example, the presentation information generation unit 102 chooses a maintenance provider suitable for necessary maintenance based on the element detected as having an abnormality, the type of abnormality, the degree of abnormality, or the service life (recommended replacement time of the element) estimated for the element detected as having the abnormality. The information pertaining to the maintenance provider may be stored in the database 404 in advance. Note that the selection processing described above may be performed by, for example, the abnormality detection information acquisition unit 101.

Note that, in this specification, the term “service life” means a recommended replacement time in maintenance unless otherwise specified. The recommended replacement time is based on the time that the element of the valve will be in a state of failure and no longer perform the desired function (“expected time to failure” described above; service life of the element in the general sense), taking into consideration a margin time for performing maintenance, and is thus shorter than the service life in the general sense. Typically, the “margin time” tends to be longer for longer periods of service life in the general sense. Further, the “margin time” tends to be longer for higher degrees of difficulty of the maintenance (higher degrees of difficulty of material procurement, higher degrees of difficulty of maintenance work, or the like). Therefore, the “margin time,” although difficult to define, is typically one to three months.

The presentation information generation unit 102 may select a maintenance provider further selected in accordance with position information pertaining to the valve, position information pertaining to the maintenance provider, and a set recommendation level for the maintenance provider. For example, the presentation information generation unit 102 determines that a provider is capable of handling the maintenance required with reference to information pertaining to the maintenance provider. In this case, the presentation information generation unit 102 may select one or more maintenance providers that have a business site geographically close to the location where the pipeline equipment of the user is installed and are set to a high priority level, and generate information pertaining to the one or more maintenance providers. The set recommendation level of a maintenance provider refers to the level of priority given to the maintenance provider with respect to the targeted maintenance. The recommendation level can be set based on, for example, past maintenance performance and past evaluations from users, and can be expressed by quantification of the performance of the maintenance provider. The quantification of the performance may be a result of scoring by users, may be performed in accordance with a reference set in advance for maintenance provider performance, or may be both.

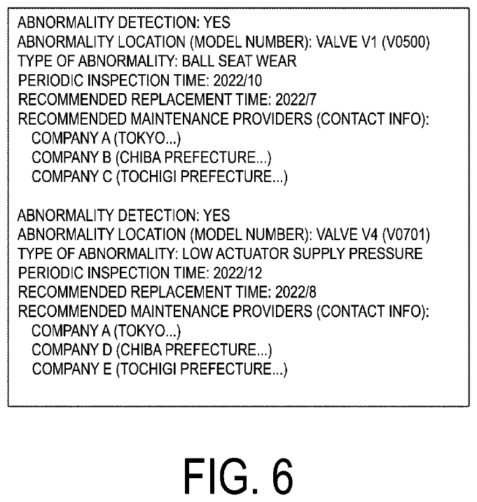

The presentation information provision unit 106 provides the presentation information generated by the presentation information generation unit 102 to the customer. The user terminal device 201 receives the presentation information, allowing the user to view the presentation information on a display screen of the user terminal device 201 and select providers who are to receive an estimate request. As illustrated in FIG. 6, the presentation information includes, for example, the presence or absence of abnormality detection, the location of or information indicating the component of the valve or actuator detected as having an abnormality, the type of abnormality, or information such as the time of periodic inspection or the recommended replacement time of the valve or actuator. In a case in which the presentation information includes information pertaining to a plurality of maintenance providers, the user may select one or more appropriate maintenance providers from among the plurality of providers. An example of the display screen displayed on the user terminal device 201 at this time will be described below with reference to FIG. 6.

### Maintenance-Related Information Provision Unit 103

The maintenance-related information provision unit 103 provides the selected maintenance provider with maintenance-related information pertaining to the element detected as having an abnormality and information pertaining to the time related to the abnormality. The maintenance-related information is information pertaining to maintenance that is required (desired) by the maintenance provider for the intended maintenance. Examples of the maintenance-related information include information indicating that the sealing material will fail (for example, angular velocity data indicating signs of an abnormality related to the sealing material, although not reaching the level of a full abnormality). Examples of the maintenance-related information pertaining to an element detected as having an abnormality include the element (sealing material, for example) structure, material, manufacturer information, vendor information, inventory of user or other maintenance providers, and price. Examples of the maintenance-related information related to information pertaining to the time related to the abnormality include information pertaining to an expected time of failure that results in loss of a desired function of the element, information pertaining to a delivery time of the element, and user work information such as a periodic inspection time of the user.

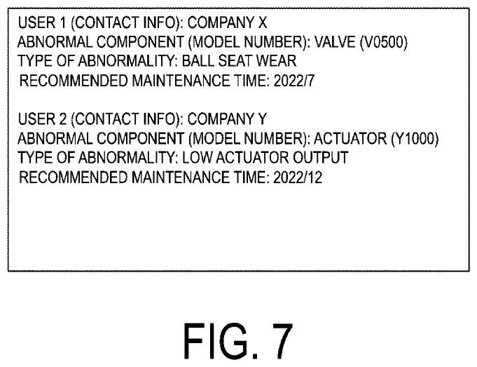

For example, the maintenance-related information provision unit 103 may transmit the maintenance-related information to the maintenance provider terminal device 203. The maintenance provider can access the user from the provider side without waiting for an inquiry from the user by viewing a display screen of the maintenance provider terminal device 203. An example of the display screen displayed on the maintenance provider terminal device 203 at this time will be described below with reference to FIG. 7.

### Estimate Acquisition Unit 104

The estimate acquisition unit 104 acquires estimates from the maintenance providers that received the maintenance-related information. For example, each estimate may be acquired in a dedicated format or may be acquired as appropriate by e-mail or facsimile (FAX). As described above, the user can select one or more maintenance providers from the providers presented in the presentation information provided by the presentation information provision unit 106 and request an estimate of the maintenance cost. The estimate acquisition unit 104 acquires an estimate from each maintenance provider in response to the estimate request from the user. The estimate may include, in addition to the cost required for maintenance, available dates for maintenance, more detailed work information of the maintenance provider, or the like. The user can select a provider to which the maintenance is to be outsourced based on the estimates from the one or more maintenance providers. The selection information pertaining to the maintenance provider selected by the user is acquired by the estimate acquisition unit 104, for example.

### Maintenance Order Unit 105

The maintenance order unit 105 places an order for maintenance with the maintenance provider selected by the customer having received the presentation information. For example, the maintenance order unit 105 transmits maintenance order information to the terminal device 203 of the maintenance provider selected by the user. Alternatively, the maintenance order unit 105 quantifies the presentation information with reference thereto, specifies a maintenance provider having the highest numerical value, and transmits the maintenance order information to the maintenance provider. Once the information processing device 100 and the user terminal device 201 receive a notification of maintenance outsource acceptance from the maintenance provider, the maintenance is performed.

### Database 404

The server 400 includes the database 404. The database 404 may store, for example, the information below.
(1) Unique information pertaining to each element in the valves
(2) Measurement data related to each element in the valves
(3) Reference data
(4) Maintenance history
(5) Maintenance provider information
(6) User information

Specific examples of each type of information may include:
(1) Model number, drawing information, design information, and purchased date of the actuator 2 or the valve 3,
(2) Measurement data such as angular velocity of the rotation shaft or air pressure of the actuator, or data related to transition over time of such measurement data,
(3) Data used for detecting an abnormality of each element by comparison with the data of (2) described above,
(4) Maintenance work content, (most recent) element replacement date, name of provider entrusted with maintenance,
(5) Contact information, operation information, maintenance work content handled, maintenance work history of each maintenance provider,
(6) Model numbers of valve units owned by each user, installation positions, user operation information, and contact information,
(7) Properties of fluid flowing through valves (toxicity, flammability, boiling point, viscosity, and slurry concentration).
(3) may be stored before shipment of each element, and the data in the initial period of (2) may be used as reference data. The “installation position” of (6) may include information pertaining to a location where the valve is disposed in the workplace such as, for example, information pertaining to whether installed in an explosion-proof area or whether installed indoors or outdoors, a scale of the plant (whether the plant is large), and the like. Further, the “user operation information” of (6) may include information pertaining to a scheduled time for periodic repair.

### Angular Velocity Data

Hereinafter, a method for detecting an abnormality of a valve from the angular velocity data measured by the gyro sensor 7 will be described with reference to FIG. 4.

FIG. 4 is a graph showing a comparison of angular velocity graphs based on valve units, plotting the angular velocity data in accordance with the valve open position. A solid line in the graph indicates the transition of angular velocity in a normal state, and is, for example, reference data. A dashed line in the graph indicates the transition of angular velocity in an abnormal state, and is, for example, angular velocity data acquired by the abnormality detection information acquisition unit 101. FIG. 4 shows the angular velocity in a case in which the ball valve is opened by a scotch yoke type pneumatic actuator.

As shown by the solid line in FIG. 4, in the normal state, three peaks are exhibited in the angular velocity data. The first peak represents operation of the actuator before power is transmitted to the valve. The second peak represents a period from when the power of the actuator starts to be transmitted for rotation of the valve to when the rotation of the valve becomes stable. When the rotation of the valve becomes stable, the angular velocity decreases. The third peak represents a period from the stable rotation of the valve to the valve being fully open. The angular velocity increases as the valve rotating stably receives power from the actuator again, and decreases to zero as the valve becomes fully open, stopping the actuator. In particular, the third peak is a peak that occurs in the case of the scotch yoke type actuator, and is a peak that occurs within a decreasing range of manual resistance between the ball seat and the ball of the ball valve, that is, in the vicinity of an intermediate open position at which the rotation operation of the ball valve is less likely to be affected. Therefore, the transition of the angular velocity data largely reflects the effects of the operation of the actuator, and is suitable for identifying the state of the scotch yoke type actuator alone. Note that, in the drawing, the intermediate open position is represented by an operation time from an end point of the second peak to the same angular velocity at the third peak and is, in terms of the open position of the valve, for example, 50 to 80° (with fully open being 90°).

The abnormality detection information acquisition unit 101 compares the acquired angular velocity data with the reference data. This will be described more specifically with reference to FIG. 4. For example, the abnormality detection information acquisition unit 101 may compare a shape or a pattern of the graph of the acquired angular velocity data with a shape or a pattern of the graph of the reference data of the comparative angular velocity, a difference in height between the angular velocities of both data, times required from fully closing the valve to the last time the valve was fully closed, or the transitions of the data. Then, the abnormality detection information acquisition unit 101 identifies that the acquired angular velocity data is changing (decreasing) as a whole at an intermediate open position of the valve (that is, a period other than the initial stage of rotation and the end stage of rotation of the ball). As a result, the abnormality detection information estimation unit 101 estimates (identifies) that the actuator 2 is operating abnormally.

Further, in the graph of the angular velocity data acquired by the abnormality detection information acquisition unit 101 (dashed line) illustrated in FIG. 4, an operation time for one operation from the start of operation of the actuator 2 to the valve 3 being fully open is long as compared with that in the graph of the comparative angular velocity data (solid line). The abnormality detection information acquisition unit 101 can estimate (identify) an abnormality based on this operation time for one operation. In the case of the abnormal state shown in FIG. 4, this phenomenon of the lengthening of the operation time is observed, and the angular velocity at an intermediate open position of the valve is low. The abnormality detection information acquisition unit 101 then, based on these features, estimates (identifies) that the operation of the actuator 2 is slow. In the case illustrated in FIG. 4, conceivably a malfunction has occurred due to water entering the actuator 2. Note that, in a case in which the phenomenon of the lengthening of the operation time for one operation is observed and the load is increased, it can be presumed that there is an abnormality in the valve 3.

As described above, by reading the graph of the angular velocity acquired by the abnormality detection information acquisition unit 101, it is possible to estimate the abnormality of the element in the valve and the type of abnormality (cause of abnormality) which are not known from the outside.

### Valve Unit

Hereinafter, a configuration of an example of a valve unit used for the angular velocity measurement described above will be described with reference to FIG. 5. FIG. 5 is a perspective view of a valve unit included in the information processing system 500 according to an embodiment of the present invention.

### Sensor Unit 1

FIG. 5 is an external perspective view of the valve unit in a state in which the sensor unit 1 is attached to the actuator 2. In FIG. 5, the valve 3 of the valve unit is in a fully open state, an X axis coincides with a flow path (26a) axial center direction, a Y axis is in a direction in which the control shaft 4 extends relative to this X axis (upward direction in the drawing), and a Z axis is a direction orthogonal to both the X axis and the Y axis and is a right-turn direction with respect to the X and Y axes.

The sensor unit 1 includes an attachment portion 6 and a sensor accommodation portion 10, and is attached in a posture parallel to an XZ plane. The attachment portion 6 is a plate-like member having an elongated parallel surface, and one end portion thereof is fixed to a distal end portion of the control shaft 4 by a holding member 5. The sensor accommodation portion 10 is disposed at the other end portion of the attachment portion 6. The gyro sensor 7 is attached to the sensor accommodation portion 10. In accordance with the rotation of a drive shaft, the gyro sensor 7 rotates in a direction indicated by an arrow in FIG. 5, drawing at least part of a virtual circle with the control shaft 4 as the center and a length of the attachment portion 6 as the radius. As a result, a detection accuracy of the gyro sensor 7 is further improved as compared with that in a case of direct attachment to the drive shaft.

The gyro sensor 7 is provided so as to be doubly eccentric with respect to the position of control shaft 4 at a reference position in which the valve 3 is in a fully open state. Note that the arrangement of the gyro sensor 7 is not limited to the structure via the attachment portion 6, and the gyro sensor 7 may be fixed at an intermediate position of the control shaft 4 in the axial direction by a fitting fixed in a form of nipping the control shaft 4, for example.

As described above, as long as attached to the output shaft or the control shaft 4, the sensor unit 1 can acquire the angular velocity data of the actuator 2 alone during the period from the operation start time of the actuator 2 to when the ball starts to rotate. Then, the degree of abnormality of the actuator 2 can be estimated from this data. Therefore, the sensor unit 1 is preferably attached to the output shaft or the control shaft 4.

The gyro sensor 7 detects rotation of the rotation shaft (control shaft 4, output shaft, and stem) as angular velocity data. In the present embodiment, state monitoring, diagnosis, and service life (replacement time) prediction of the valve 3 and the actuator 2 are performed based on the angular velocity data of the rotation shaft.

The gyro sensor 7 is a vibration-type gyro sensor that uses integrated circuit (IC) type micro-electromechanical system (MEMS) technology, is a semiconductor type, and is included in the inner substrate. Specifically, the gyro sensor is a triaxial gyro sensor capable of measuring rotation in three orthogonal XYZ axial directions. However, these features are not restrictive and of course can be selected and adjusted as desired in accordance with the implementation.

In addition, the sensor unit 1 may combine a temperature sensor, an acceleration sensor, a magnetic sensor, or the like (not illustrated). To save power, a piezoelectric sensor may be combined to activate the gyro sensor 7 when necessary.

Note that, in the present embodiment, an aspect in which the angular velocity is detected by the gyro sensor 7 is exemplified, but the present invention is not limited thereto, and another angular velocity sensor, such as an encoder or an acceleration sensor, for example, may be used as long as the angular velocity can be detected. However, the gyro sensor is more preferable than the acceleration sensor in that the gyro sensor can accommodate both vertical and horizontal piping, can be installed in any orientation, and a single gyro sensor can accommodate operation in a plurality of directions.

### Actuator 2

In the present embodiment, an actuator of a pneumatic rotary type having a double-acting scotch yoke structure is adopted as the actuator 2. The actuator 2 is coupled to the valve 3 via a bracket 34. Note that a tap bolt 33 adjusts a tightening of a packing presser against the stem coupled to the output shaft of the actuator 2.

The actuator 2 is provided with a conversion mechanism that converts reciprocating motion into rotational motion inside the main body, and a rotational force of this conversion mechanism can be output to the stem of the valve 3 by the output shaft.

A cylinder portion 19 is fixed to one side of the housing 18, that is, the right side in FIG. 5, and a piston is accommodated in a cylinder case of this cylinder portion 19. The example herein is of a double-acting type in which air intake/exhaust ports 38, 39 are provided in the cylinder portion 19, and the piston reciprocates in accordance with the intake/exhaust of compressed air to and from air chambers via the air intake/exhaust ports 38, 39, causing the piston rod to linearly reciprocate. This motion is transmitted to the scotch yoke and converted into rotational motion.

Note that a pressure sensor (not illustrated) can be provided to the actuator 2 as appropriate in accordance with the implementation. In this case, for example, a speed controller (not illustrated) may be provided to the air intake/exhaust ports 38, 39, and the pressure sensor may be connected between the air intake/exhaust ports 38, 39 and the speed controller via a coupling such as a T-tube or nipple tube. With such a configuration, a pressure sensor can be mounted to a branch portion of the T-tube, allowing the pressure to be measured by the pressure sensor with a simple structure without adversely affecting the intake/exhaust of compressed air.

In the present embodiment, an example in which a pneumatic actuator is used as an actuator for automatic operation has been described. In the case of a pneumatic actuator, the actuator is driven by receiving a supply of air, and thus does not require a power source, resulting in the advantage that the valve system of the present invention can be installed even in a plant in an explosion-proof area or a large-scale plant where power source installation is difficult. However, other than a pneumatic actuator, the actuator may be a hydraulic actuator or an electric actuator.

### Valve 3

In the present embodiment, the valve 3 is a rotary valve that opens and closes a flow path by rotating a rotation shaft. Note that the rotation shaft is not limited to a rotation shaft of an automatic valve, and may be a rotation shaft formed of a stem of a manual valve via a manual handle (not illustrated). In the present embodiment, the valve 3 is the ball valve of a quarter-turn type. However, in addition to such a valve, various rotary valves including motor-driven types such as a plug valve, a butterfly valve, or a ball valve of a 180-degree rotating type may be used.

### Operation of Information Processing Device 100 (Information Processing Method)

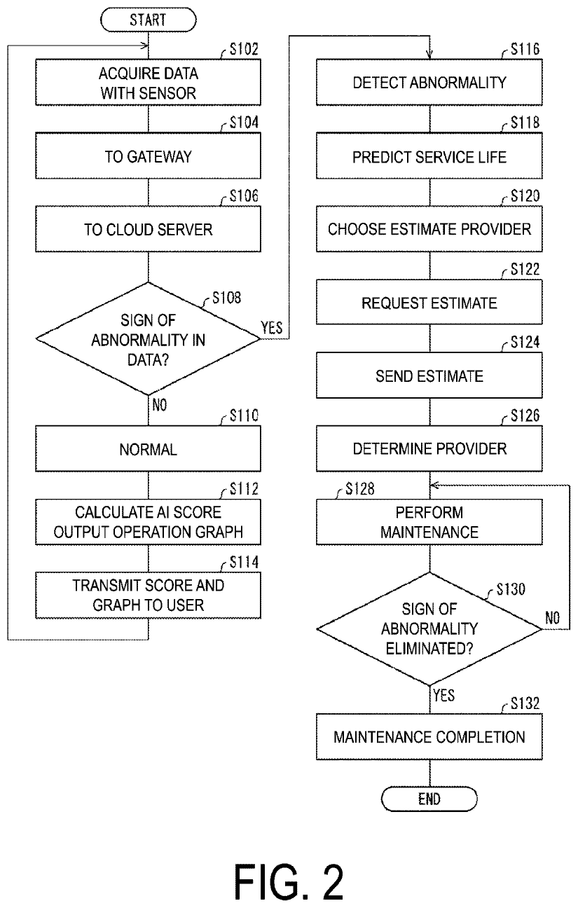

FIG. 2 is a flowchart illustrating a processing flow of the information processing system 100 described above. Hereinafter, the processing flow until maintenance performance in the information processing device 100 will be described with reference to FIG. 2.

### Step S102

The gyro sensor 7 provided in each of the valve units V1 to V4 detects angular velocity data of the rotation shaft for rotating the ball of the valve.

### Steps S104 and S106

A communication unit (not illustrated) of the pipeline equipment PL transmits the angular velocity data detected in step S102 to the server 400 via the gateway 600.

### Step S108

The abnormality detection information acquisition unit 101 receives the angular velocity data transmitted in step S106. Then, the abnormality detection information acquisition unit 101 acquires abnormality detection information including abnormality detection data related to each of the plurality of elements in the valves based on the received angular velocity data. That is, the abnormality detection information acquisition unit 101 acquires the abnormality detection information based on the received angular velocity data, and determines whether an abnormality exists in each element of the valves. The method for determining whether an abnormality exists in each element of the valves has been described above in the “Angular Velocity Data” section. When the abnormality detection information acquisition unit 101 determines that an abnormality does not exist in an element of the valves (NO in step S108), the processing proceeds to step S110. When the abnormality detection information acquisition unit 101 determines that an abnormality exists in an element of the valves (YES in step S108), the processing proceeds to step S116.

### Step S110

The abnormality detection information acquisition unit 101, having determined that an abnormality does not exist in an element of the valves, determines that each of the plurality of elements of the valves is normal.

### Step S112

The abnormality detection information acquisition unit 101 performs arithmetic processing on the angular velocity data detected by the gyro sensor 7 to calculate an AI score or to output an operation graph. The AI score is, for example, a value obtained by performing arithmetic processing on the angular velocity data, and can be displayed as a graph for the purpose of visualizing a soundness of the valves. Both the AI score and the operation graph may be used to confirm the occurrence of an abnormality and specify the abnormality location. For example, the soundness of the valves may be checked by the AI score and, when an abnormality reaches a certain level, the operation graph of the angular velocity data may be checked to specify the abnormality location. The output AI score or operation graph may be stored in the database 404.

### Step S114

The communication unit (not illustrated) of the information processing device 100 transmits the AI score or the operation graph output in step S112 to the user terminal device 201. Subsequently, the processing returns to step S102, and the processing from step S102 to step S1114 is repeated.

### Step S116

The abnormality detection information acquisition unit 101 determines that an abnormality exists in an element of the valves.

### Step S118

The abnormality detection information acquisition unit 101, based on the angular velocity data detected by the gyro sensor 7, predicts the service life, that is, the recommended replacement time, of the element detected as having the abnormality. Subsequently, the abnormality detection information acquisition unit 101 transmits the abnormality detection information and the information pertaining to the time related to the abnormality to the presentation information generation unit 102.

### Step S120

The presentation information generation unit 102 generates presentation information for presenting, to a customer being a user of the valve, maintenance providers selected in accordance with the element detected as having an abnormality and the information pertaining to the time related to the abnormality, the element and the information being based on the abnormality detection information. The presentation information includes, for example, a name or a model number of a component of the valve or the actuator that requires replacement, data of a product name or a model number of the valve in a case in which the valve itself is to be replaced, or a list of rival valve or actuator products of other companies that satisfy the same specifications. At this time, the presentation information generation unit 102 may further select the selected maintenance providers in accordance with valve position information, maintenance provider position information, and set recommendation levels of the maintenance providers.

For example, in a case in which the database 404 has information on the location of the plant where the valve is installed, a higher recommendation level can be set for a maintenance provider at a location or having a business site close to the plant.

Further, the database 404 may have information pertaining to the valves maintained per maintenance provider, such as the valve types or actuator components for which each maintenance provider has experience and expertise in maintaining. In this case, the recommendation level of the maintenance provider can be set in accordance with that information.

According to such selection of maintenance providers, from the perspective of the user, not only can estimates be automatically received, but an appropriate maintenance provider can be selected in accordance with the cause of the abnormality or the product and component to be maintained.

Note that, in addition, with reference to ratings or reviews acquired from other users, the specific maintenance providers may be arranged in descending order of rating. This allows the user to identify a maintenance provider capable of providing a higher quality service, thereby improving a maintenance quality. In addition, an appropriate maintenance provider may be selected by combining the elements described above.

The presentation information provision unit 106 presents the presentation information generated by the presentation information generation unit 102 to the user. For example, the presentation information provision unit 106 transmits the presentation information to the user terminal device 201. The user may view the presentation information on the display screen of the user terminal device 201 and select one or more maintenance providers from among the maintenance providers included in the presentation information.

### Step S122

The user requests an estimate from the one or more maintenance providers selected from the providers included in the presentation information. Further, at this time, the maintenance-related information related to the element detected as having an abnormality and the information pertaining to the time related to the abnormality may be provided to the selected maintenance providers.

### Step S124

Upon receipt of the request for an estimate, the maintenance provider returns an estimate of the amount of money required for the maintenance or the delivery date to the user. For example, the maintenance provider transmits an estimate from the maintenance provider terminal device 203 to the user terminal device 201. The estimate acquisition unit 104 acquires the estimate from the maintenance provider that received the maintenance-related information. In a case in which an estimate is requested from a plurality of maintenance providers, the estimates may be acquired from the plurality of maintenance providers.

### Step S126

The user selects (determines) the provider to be entrusted with the maintenance. When estimates are acquired from a plurality of providers, an optimum provider may be selected from the providers. Subsequently, the maintenance order unit 105 places an order for maintenance with the maintenance provider selected by the customer having received the presentation information.

### Step S128

The selected maintenance provider performs the maintenance.

### Step S130

After the maintenance is performed, the abnormality detection information acquisition unit 101 determines whether abnormalities have been eliminated for each of the plurality of elements in the valves. When the abnormality detection information acquisition unit 101 determines that the abnormalities have been eliminated (YES in step S130), the processing proceeds to step S132. When the abnormality detection information acquisition unit 101 determines that the abnormalities have not been eliminated (NO in step S130), the processing returns to step S130.

### Step S132

The maintenance is completed. Thus, the series of processing is completed.

### Flow of Information in Information Processing System

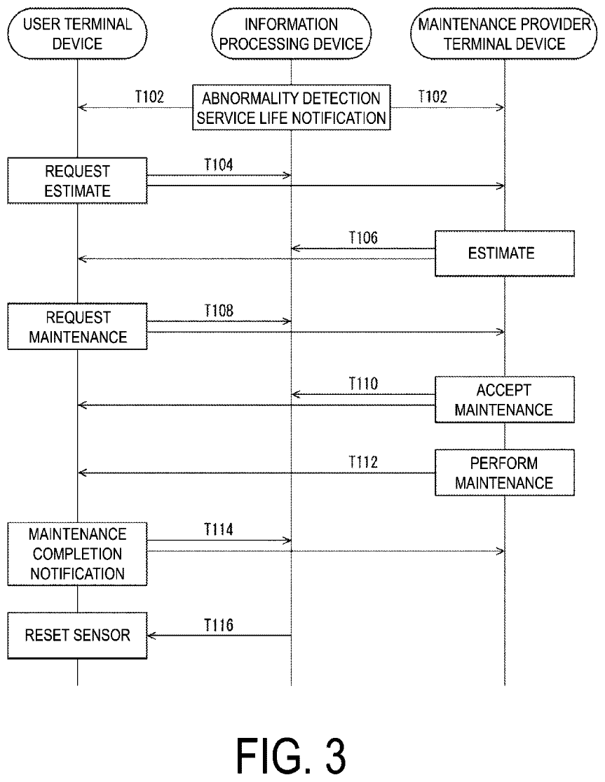

Next, the flow of information in the information processing system 500 will be described with reference to FIG. 3. In the information processing system 500, information is transmitted and received between the information processing device 100 (terminal device 202), the user terminal device 201, and the maintenance provider terminal device 203.

### T102

The abnormality detection information and the information pertaining to the time related to the abnormality (service life notification of the element detected as having an abnormality) acquired by the abnormality detection information acquisition unit 101 are transmitted from the information processing device 100 to the user terminal device 201 and the maintenance provider terminal device 203.

### T104

The user requests estimates for maintenance from the maintenance providers selected in accordance with the information pertaining to the element detected as having an abnormality and the time related to the abnormality. The information pertaining to the request for an estimate is transmitted from the user terminal device 201 to the information processing device 100 and each maintenance provider terminal device 203.

### T106

The maintenance providers each transmit the estimate from the maintenance provider terminal device 203 to the user terminal device 201 and the estimate acquisition unit 104 of the information processing device 100.

### T108

The user having received the estimates selects a provider to be entrusted with the maintenance.

The maintenance order unit 105 places an order for maintenance with the maintenance provider selected by the customer having received the presentation information. At this time, the maintenance order unit 105 transmits the maintenance order information from the user terminal device 201 to the information processing device 100 and the maintenance provider terminal device 203.

### T110

The maintenance provider accepts the maintenance. The maintenance provider transmits maintenance acceptance information from the maintenance provider terminal device 203 to the user terminal device 201 and the information processing device 100.

### T112

The maintenance provider entrusted with the maintenance performs the maintenance.

### T114

When the maintenance is completed, the user transmits a maintenance completion notification from the user terminal device 201 to the information processing device 100 and the maintenance provider terminal device 203.

### T116

In the user terminal device 201, the sensor is reset. In response to the maintenance completion notification from the user terminal device 201, the sensor may be reset by the information processing device 100 transmitting a sensor reset signal or a notification prompting the user to reset the sensor to the user terminal device 201.

### Display Screen of User Terminal Device

Next, an example of the display screen of the presentation information of the user terminal device 201 will be described with reference to FIG. 6. The user terminal device 201 displays the presentation information received from the presentation information generation unit 102 on the display screen. As an example of the presentation information, presence or absence of abnormality detection, detected abnormality location, type of abnormality, periodic inspection time, recommended replacement time, recommended maintenance providers, and the like are displayed on the display screen, as illustrated in FIG. 7. In the example of FIG. 6, the abnormality detection information pertaining to the elements included in all valve units V1 to V4 owned by the user in the same region is displayed.

This abnormality detection information indicates that, among the valve units V1 to V4, abnormalities are detected in the valve units V1, V4, and abnormalities are not detected in the valve units V2, V3.

Further, the types of abnormalities detected in the valve units V1, V4 are also displayed. For example, ball seat wear is displayed for the valve unit V1, and low actuator supply pressure is displayed for the valve unit V4.

For the valve unit V1, a specific maintenance provider exists and thus a periodic inspection time (October 2022) is displayed. Further, the recommended replacement time (July 2022) of the element (ball seat) estimated from the abnormality detection information acquired by the abnormality detection information acquisition unit 101 is also displayed. For the valve unit V1, it can be seen that the recommended replacement time of the element is before the periodic inspection time.

Furthermore, the presentation information generation unit 102 displays information pertaining to the maintenance providers selected in accordance with the information pertaining to the element detected as having an abnormality and the time related to the abnormality. In FIG. 6, a plurality of maintenance providers A, B, C are displayed as an example. Here, the plurality of maintenance providers may be displayed in descending order of recommendation level. The information pertaining to the maintenance providers may include, in addition to the contact information of the maintenance providers, the work content of the maintenance handled, operation information, and the like.

For the valve unit V2 as well, a specific maintenance provider exists and thus the periodic inspection time (December 2022) is displayed. The recommended replacement time (August 2022) of the element (actuator) is also displayed. For the valve unit V2 as well, it can be seen that the recommended replacement time is before the periodic inspection time.

Furthermore, information pertaining to the selected maintenance providers is displayed. In FIG. 6, a plurality of maintenance providers A, D, E are displayed as an example.

Based on the displayed information, the user can select one or more providers who are to receive a request for an estimate. In the case of the example illustrated in FIG. 6, preferably the provider A recommended for both of the valve units V1, V4 is selected.

### Display Screen of Maintenance Provider Terminal Device

Next, an example of the display screen of the maintenance provider terminal device 203 will be described with reference to FIG. 7. The information provided by the maintenance-related information provision unit 103 is displayed on the maintenance provider terminal device 203. In the example of FIG. 7, information pertaining to two users (company X and company Y) is displayed.

More specifically, the information (name, contact information, and the like) of each user, a component (model number) detected as having an abnormality for each user, the type of abnormality, and the recommended maintenance time are displayed. In the example of FIG. 7, for user 1 (company X), valve ball seat wear is displayed as the type of abnormality and “July 2022” is displayed as the recommended maintenance time. For user 2 (company Y), low actuator output is displayed and, as the recommended maintenance time, “December 2022” is displayed.

The maintenance provider can, based on the displayed information, access the user wanting to outsource the maintenance without waiting for an estimate request from the user.

According to the information processing system described above, it is possible not only to detect an abnormality in a valve unit and estimate a recommended replacement time of an element (component) included in the valve unit, but also easily select an appropriate maintenance provider in accordance with the type of detected abnormality and other information. This allows the user to outsource the maintenance to an appropriate maintenance provider at an appropriate timing. Furthermore, by acquiring the maintenance-related information, the maintenance provider can access the user without waiting for an estimate request or a maintenance order from the user.

The information processing according to an embodiment of the present invention may include further processing within a range in which the effects of the present invention can be achieved. For example, the information processing can be applied to both a case in which the user selects a maintenance provider on a case-by-case basis, and a case in which maintenance is included as part of a specific service available to the user for a predetermined period (subscription, lease, or the like). The information processing in an embodiment of the present invention may include information processing according to such a business model.

For example, the information processing according to an embodiment of the present invention may include a process of notifying the user of a maintenance completion report in response to a notification of maintenance completion from a maintenance provider. For example, the information processing system 500 may further include a functional configuration configured to receive a notification of maintenance completion from a maintenance provider, create data of a maintenance completion report with reference to maintenance-related information pertaining to the maintenance, and transmit the created completion report data to the user. In this case, the completion report may include information pertaining to subsequent maintenance (such as the information pertaining to the recommended replacement time described above or an estimated time or notice of the next maintenance). Such a configuration is advantageous from the viewpoint of seamlessly advancing a business model in which a user pays a cost to a maintenance provider for each maintenance.

Further, the information processing according to an embodiment of the present invention may include a process of newly registering a maintenance provider. For example, the information processing system 500 may further include a functional configuration configured to sequentially acquire registration applications from new maintenance providers and sequentially store the acquired information pertaining to the maintenance providers in the database 404. Such a configuration is advantageous from the viewpoint of acquiring maintenance providers corresponding to the position information pertaining to the valve (user) and from the viewpoint of improving the maintenance service to the user.

Further, the information processing according to an embodiment of the present invention may include a process of updating information referenced in the information processing based on information pertaining to the completed maintenance. For example, the information processing system 500 may further include a functional configuration configured to acquire, after maintenance completion, information pertaining to a rating of the maintenance provider by the user having placed the order for the maintenance, determine a recommendation level of the maintenance provider according to the acquired rating information, and store the determined recommendation level information in the database 404 as maintenance provider information pertaining to the maintenance provider. Such a configuration is advantageous from the viewpoint of making it possible for the user to select an optimum maintenance provider.

Further, the information processing according to an embodiment of the present invention may include a process of updating the reference data used for comparison when the abnormality is detected based on the information pertaining to the completed maintenance. For example, the information processing system 500 may further include a functional configuration configured to acquire inspection data of an acquired object (used ball, sealing material, or the like) from the completed maintenance, determine a threshold value of abnormality detection with reference to the inspection data, and store the determined threshold value in the database 404 as a threshold value for subsequent abnormality detection. Examples of the inspection data include surface state (surface roughness, friction coefficient, and the like) test results, rupture test results, and acceleration test results for further use. Such a configuration is advantageous from the viewpoint of appropriately updating the reference data and thus improving the accuracy of abnormality detection.

Further, the information processing according to an embodiment of the present invention may include a process of providing billing to a registered maintenance provider based on the information pertaining to completed maintenance. For example, the information processing system 500 may further include a functional configuration configured to determine, for the maintenance provider that received the maintenance order, a fee according to the maintenance provider information and notify the maintenance provider of information pertaining to the determined fee after completion of the maintenance. The fee can be determined, for example, according to specific technical certification results held by the maintenance provider. Such a configuration is advantageous from the viewpoint of maintaining the maintenance quality and the information processing system.

Further, in the information processing according to an embodiment of the present invention, the handling of information pertaining to maintenance may be changed in accordance with the business model. For example, the information processing according to an embodiment of the present invention may include, in a business model in which a certain service is provided at a fixed rate, such as with a subscription or a lease contract, a process of determining the rating of the maintenance provider with reference to estimate information acquired from the maintenance provider. In this case, the information processing system 500 may further include a functional configuration configured to refer to the estimate information acquired by the estimate acquisition unit 104 from the maintenance provider having received the maintenance order after maintenance completion, extract maintenance items exceeding the estimate information, determine the recommendation level of the maintenance provider according to the level of exceedance of the maintenance result, and store the determined recommendation level information in the database 404 as maintenance provider information pertaining to the maintenance provider. Such a configuration is advantageous from the viewpoint of making it possible for the user to select an appropriate maintenance provider.

Further, in the information processing according to an embodiment of the present invention, the abnormality detection information acquisition unit may acquire the abnormality detection information with further reference to second output information pertaining to the valve unit other than the output information of the angular velocity sensor.

The second output information is data other than the angular velocity data and is information facilitating detection of an abnormality in an element of the valve unit. Examples of the second output information include flow rate data of a flow rate sensor of the valve and data of an acoustic emission (AE) sensor. The second output information may be included in the information processing system of the present embodiment, but may be acquired from a sensor separately included in the pipeline equipment PL of the user as long as permission is obtained from the user.

Acquiring the abnormality detection information with further reference to the second output information is advantageous from the viewpoint of facilitating reinforcement of abnormality detection based on the angular velocity data and thus further improving a reliability of the abnormality detection information. In addition, making further reference to the second output information is advantageous from the viewpoint of facilitating detection or estimation of an amount of change due to the abnormality or the degree of the abnormality, such as, for example, a leakage amount of fluid from a seal, or improving the accuracy thereof.

### Software Implementation Example

The control blocks of the information processing device 100 (in particular, the abnormality detection information acquisition unit 101, the presentation information generation unit 102, and the maintenance-related information provision unit 103) may be realized by a logic circuit (hardware) formed in an integrated circuit (IC chip) or the like, or may be realized by software. In the latter case, the information processing device 100 is configured by using, for example, a computer (electronic calculator).

### Physical Configuration of Information Processing Device 100

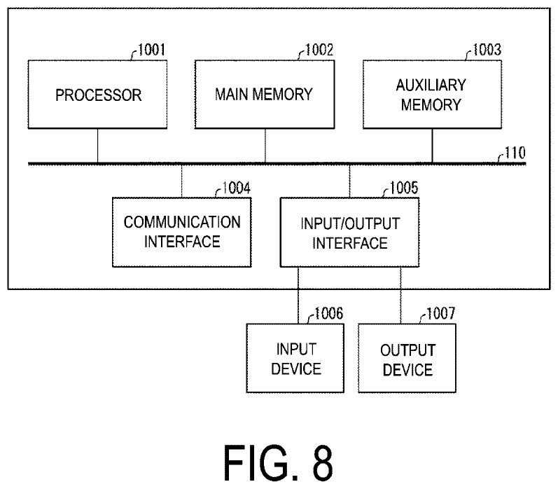

FIG. 8 is a block diagram illustrating a physical configuration of a computer used as the information processing device 100. As illustrated in FIG. 8, the information processing device 100 can be constituted by a computer including a bus 110, a processor 1001, a main memory 1002, an auxiliary memory 1003, a communication interface 1004, and an input/output interface 1005. The processor 1001, the main memory 1002, the auxiliary memory 1003, the communication interface 1004, and the input/output interface 1005 are connected to one another via the bus 110. An input device 1006 and an output device 1007 are connected to the input/output interface 1005.

As the processor 1001, for example, a central processing unit (CPU), a microprocessor, a digital signal processor, a microcontroller, or a combination thereof is used.

As the main memory 1002, for example, a semiconductor random access memory (RAM) is used.

As the auxiliary memory 1003, for example, a flash memory, a hard disk drive (HDD), a solid state drive (SSD), or a combination thereof is used. The auxiliary memory 1003 stores a program for causing the processor 1001 to execute the above-described operation of the information processing device 100. The processor 1001 loads the program stored in the auxiliary memory 1003 into the main memory 1002 and executes each command included in the loaded program.

The communication interface 1004 is an interface connected to a network (Internet 800, for example).

As the input/output interface 1005, for example, a universal serial bus (USB) interface, an infrared or short-range communication interface such as Bluetooth (trade name), or a combination thereof is used.

As the input device 1006, for example, a keyboard, a mouse, a touch pad, a microphone, or a combination thereof is used. As the output device 1007, for example, a display, a printer, a speaker, or a combination thereof is used.

Note that, although the information processing system 500 includes the information processing device 100, the information processing system of the present invention may be constructed by linking various configurations including the functional configuration of the information processing device 100 without including the information processing device 100.

### Second Embodiment

Another embodiment of the present invention will be described below. Prediction of the recommended replacement time may change due to an unexpected external factor. An unexpected external factor is a factor external to the control of the valve unit that causes a valve unit element to deteriorate rapidly, examples of which include a rapid increase in an operating flow rate of a valve, a reduction in ambient temperature, and frequent water hammer events. In this case, although the prediction before the change and the maintenance plan based thereon are not flawed, such a change in the result of the prediction of the recommended replacement time may result in a change in the appropriate maintenance work and a change in the appropriate maintenance provider to be entrusted therewith. The present embodiment is the same as the first embodiment described above other than execution of processing according to a newly estimated recommended replacement time. Note that, for convenience of description, the description of content identical to aspects of the embodiment described above will not be repeated.

In the present embodiment, the information processing device 100 includes a maintenance capability information acquisition unit. The maintenance capability information acquisition unit is a functional configuration configured to acquire maintenance capability information pertaining to a maintenance provider, and is a functional configuration including the estimate acquisition unit 104 described above. The “maintenance capability information” includes not only the estimate described above, but also a wide range of information pertaining to the maintenance of the maintenance provider, and is information pertaining to elements for which the maintenance provider can perform maintenance at that time. While the maintenance-related information is, of the information pertaining to maintenance described above, the information requested by the maintenance provider for the intended maintenance, the maintenance capability information is, of the maintenance information, information disclosed to the user by the provider with regard to the intended maintenance. Examples of the maintenance capability information include, in addition to the maintenance-related information described above, an inventory of the components of the maintenance provider, the presence or absence of devices to be used for maintenance, and the schedule (busyness) of the maintenance provider over a period until the recommended new replacement time.

The maintenance capability information may be input information from the maintenance provider, or may be information pertaining to the maintenance provider that is input information acquirable via a network of a server. When the maintenance capability information is acquired from a network, the maintenance capability information acquisition unit may acquire the maintenance capability information each time the information is updated, or may acquire the information at a specific interval. For example, the maintenance provider can access this system from his or her terminal and store, in the database 404 of the server via the network, maintenance capability information such as a state of busyness including his or her on maintenance work schedule, types of valves handled, and information pertaining to possessed equipment and components as input information. Further, each maintenance provider can periodically update the stored information, allowing the user to view the latest maintenance capability information for each provider at the time of requesting maintenance, and can choose the optimum provider based on the maintenance capability information. The optimum provider may be determined by the user or may be appropriately determined in accordance with the maintenance work to be performed. Examples thereof include a provider that can perform maintenance the earliest, a provider that can perform maintenance at the lowest cost, and a maintenance provider having the greatest maintenance experience and a favorable reputation at the time of requesting the maintenance work.

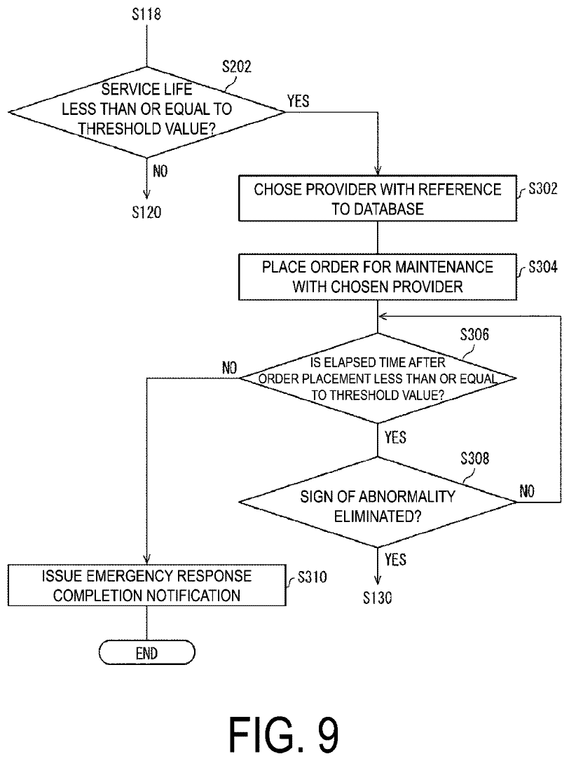

An example of an information processing method according to the present embodiment will now be described. FIG. 9 is a flowchart illustrating a main portion of a processing flow of the information processing system according to the present embodiment. The gyro sensor 7 newly detects angular velocity data of the rotation shaft. The abnormality detection information acquisition unit 101 acquires the abnormality detection information and determines that an abnormality exists in an element in a valve. In step 118, the abnormality detection information acquisition unit 101 predicts a new service life (recommended replacement time) of the element detected as having the abnormality based on the new angular velocity data.

In step S202, the abnormality detection information acquisition unit 101 determines whether the newly predicted service life is equal to or less than a threshold value with reference to the immediately preceding predicted service life. For example, the abnormality detection information acquisition unit 101 determines whether a difference obtained by subtracting, from a newly predicted service life Tn, an immediately preceding service life Tn-1 and a time difference At between the immediately preceding detection time and the new detection time is equal to or less than the threshold value. Here, the “threshold value” is a value corresponding to a remaining period during which maintenance placed through a normal order placed by the user can be performed. For example, the “threshold value” is set to a period during which the maintenance provider can immediately perform maintenance from maintenance start to maintenance finish, and herein is equivalent to, for example, two months.

When the service life exceeds the threshold value in step S202, in step S120, the presentation information generation unit 102 generates presentation information, and the presentation information provision unit 106 presents the presentation information to the user.

When the service life is equal to or less than the predetermined value in step S202, in step 302, the presentation information generation unit 102 refers to the database 404 and chooses a maintenance provider capable of completing maintenance within the range of the newly predicted service life. For example, the presentation information generation unit 102 refers to the maintenance capability information stored in the database 404 and chooses a maintenance provider having a higher degree of satisfaction with respect to various maintenance requirements such as time, materials, equipment, and personnel.

In step S304, the maintenance order unit 105 places an order for the maintenance as emergency maintenance with the maintenance provider chosen by the presentation information generation unit 102.

In step S306, the abnormality detection information acquisition unit 101 detects an elapsed time after order placement, and determines whether the elapsed time is less than or equal to a threshold value. Here, the “threshold value” is a value corresponding to a period during which the chosen maintenance provider should complete the emergency maintenance. The threshold value may include a value corresponding to a grace period according to a difference between the service life in step 202 and the threshold value. In the present embodiment, the threshold value is equivalent to, for example, one month.

When the elapsed time in step S306 is equal to or less than the threshold value, the abnormality detection information acquisition unit 101 determines whether abnormalities have been eliminated for each of the plurality of elements in the valves in step S308. When the abnormality detection information acquisition unit 101 determines that the abnormality has been eliminated (YES in step S308), the processing proceeds to step S130. When the abnormality detection information acquisition unit 101 determines that the abnormalities have not been eliminated (NO in step S308), the processing returns to step S306.

When the elapsed time exceeds the threshold value in step S306, the abnormality detection information acquisition unit 101 notifies the user of the end of emergency response in step S310.

Next, the flow of information in the information processing system of the present embodiment will be described. When the service life exceeds the predetermined value in step S202, the information processing device 100 transmits the most recent service life to the user terminal device 201 and the maintenance provider terminal device 203. Otherwise, the flow of information is the same as that of the first embodiment described above.

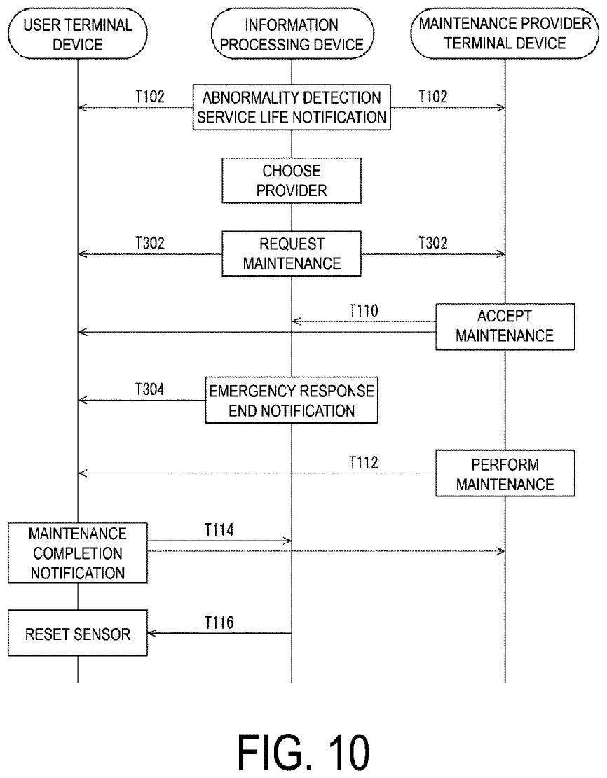

A case in which the service life is less than or equal to the predetermined value in step S202 will now be described. FIG. 10 is a sequence diagram illustrating the flow of information in a case in which emergency maintenance is performed in an information processing system according to the present embodiment.

### T102

When the service life is equal to or less than the threshold value in step S202, the information processing device 100 transmits the most recent service life information from the information processing device 100 to the user terminal device 201 and the maintenance provider terminal device 203. Then, in the information processing device 100, a maintenance provider is chosen.

### T302

The selected maintenance provider and the emergency maintenance request are transmitted from the information processing device 100 to the user terminal device 201 and the maintenance provider terminal device 203 of the chosen maintenance provider.

Regardless of the presence or absence of maintenance acceptance information from the maintenance provider in T110, when the elapsed time from order placement of emergency maintenance in step S306 exceeds a threshold value, a notification of the end of emergency response is transmitted from the information processing device 100 to the user terminal device 201. The user having received the notification of the end of emergency response places an order for maintenance with a specific maintenance provider or interrupts or inspects the operation of the pipeline equipment PL.

When the maintenance provider performs emergency maintenance at T112 and the abnormality detection information acquisition unit 101 determines that the abnormality has been eliminated in step S308, the information processing device 100 does not transmit the notification of the end of emergency response to the user terminal device 201.

### T114

When the emergency maintenance is completed in response to determining that the abnormality has been eliminated, a maintenance completion notification is transmitted from the user terminal device 201 to the information processing device 100 and the maintenance provider terminal device 203.

### T116

In the user terminal device 201, the sensor is reset. For example, in response to one or both of determining that the abnormality has been eliminated in step S308 and the reception of the maintenance completion notification from the user terminal device 201, a signal for resetting the sensor or a notification indicating that the sensor can be reset is transmitted from the information processing device 100 to the user terminal device 201. In response to the signal or the notification, the sensor is reset in the user terminal device 201.

Thus, in the present embodiment, the information pertaining to the time related to the abnormality includes an amount of change in the service life according to the current prediction with respect to the service life according to the immediately preceding prediction. Accordingly, the present embodiment is advantageous from the viewpoint of outsourcing maintenance corresponding to a change in the recommended replacement time to a maintenance provider.

Further, in the present embodiment, the presentation information generation unit 102 selects a maintenance provider with further reference to the maintenance capability information acquired by the maintenance capability information acquisition unit described above. Accordingly, the present embodiment is advantageous from the viewpoint of outsourcing maintenance to a maintenance provider capable of appropriately handling a change in the recommended replacement time.

Furthermore, in the present embodiment, the maintenance order unit 105 places an order for maintenance with the maintenance provider selected by the presentation information generation unit 102 in accordance with the amount of change in the time (service life) described above. That is, in the present embodiment, when the service life shortens and the amount of change thereof is significant, the order for the maintenance of the valve unit abnormality is directly placed with the maintenance provider without going through the user. Accordingly, the present embodiment is advantageous from the viewpoint that maintenance can be appropriately outsourced to a maintenance provider even for an abnormality requiring an emergency response.

In the present embodiment, information processing other than the above may be performed to the extent that the effects of the present invention can be achieved.

For example, as described above, the newly predicted service life Tn is a value obtained by subtracting “a margin time for performing maintenance” from the remaining “typical service life of the element.” In an embodiment of the present invention, the service life Tn may include first time information that is a shorter time or may include second time information that is a longer time. The newly predicted service life Tn including the first time information (for example, a period one month shorter than the value of the service life calculated by normal prediction) is advantageous from the viewpoint of more quickly responding to the maintenance based on the changed service life newly predicted.

The newly predicted service life Tn including the second time information (for example, a period 0.5 months longer than the value of the service life calculated by normal prediction) is advantageous from the viewpoint of increasing the number of maintenance providers that can handle maintenance based on a change in predicted service life and further increasing the feasibility of such maintenance. When the second time information is included, the abnormality state typically stops progressing once maintenance is started, and thus a longer period (0.5 months in the example described above) can be determined as appropriate based on the relationship between, for example, the “margin time” described above and the expected time from the start of maintenance to cessation of the abnormality.

The first time information and the second time information may be determined in advance in accordance with the element undergoing failure prediction and the failure content, or may be calculated on a case-by-case basis. In the case of placing an order for maintenance including one or both of the first time information and the second time information, a maintenance provider that can handle a period determined by a combination of two of the newly predicted service life, the first time information, and the second time information may be chosen when choosing a provider in step S302.

Further, in an embodiment of the present invention, the comparison between the service life and the threshold value in step S202 may be a comparison based on a ratio between the most recent service life and the new service life, for example, Tn/(Tn-1−Δt). In this case, in the comparison determination in step S202, the emergency level increases as the ratio decreases. Therefore, the processing proceeds to step S120 when the service life exceeds the threshold value, and proceeds to step S302 when the service life is equal to or less than the threshold value. Further, the threshold value in this case is a value equivalent to the period during which the progress of the maintenance work based on the most recent service life makes it difficult to perform emergency maintenance. The threshold value in this case may be, for example, a value corresponding to a remaining period during which maintenance can be performed through a normal order placed by the user with respect to the most recent service life. The threshold value may be determined on a case-by-case basis with reference to the maintenance capability information pertaining to the maintenance provider and the information pertaining to the estimate of the maintenance based on the most recent service life.

Further, in an embodiment of the present invention, the maintenance order unit 105 may place an order for emergency maintenance with reference to not only the amount of change in the time described above but also other information. For example, the maintenance order unit 105 may place an order for emergency maintenance with the maintenance provider selected by the presentation information generation unit 102 in accordance with outsourcing information from the user. Such an aspect is advantageous from the viewpoint of automatically implementing an emergency response when permission from the user is obtained in advance as outsourcing information before the occurrence of an unexpected abnormality, making it possible to quickly and reliably respond to an unexpected abnormality while meeting the expectations of the user.

### Summary

An information processing device according to a first aspect of the present invention includes: an abnormality detection information acquisition unit configured to acquire abnormality detection information including abnormality detection data related to each of a plurality of elements in a valve; a presentation information generation unit configured to generate presentation information for presenting, to a customer being a user of the valve, maintenance providers selected in accordance with one of the plurality of elements in which an abnormality is detected based on the abnormality detection information and information pertaining to a time related to the abnormality; and a maintenance-related information provision unit configured to provide, to the selected maintenance providers, maintenance-related information related to the one of the plurality of elements in which the abnormality is detected and the information pertaining to the time related to the abnormality.

According to the first aspect described above, it is possible to detect abnormalities related to each of the plurality of elements in the valve, estimate a recommended time for maintenance, and present appropriate maintenance providers to the user.

In the information processing device according to a second aspect of the present invention, in the first aspect described above, the information processing device further includes: an estimate acquisition unit configured to acquire an estimate from the maintenance providers having received the maintenance-related information; a presentation information provision unit configured to provide, to the customer, the presentation information generated by the presentation information generating unit; and a maintenance order unit configured to place an order for maintenance with one of the maintenance providers selected by the customer having received the presentation information.

According to the second aspect described above, it is possible to promptly outsource the maintenance service to a maintenance provider based on estimate results.

In the information processing device according to a third aspect of the present invention, in the first or second aspect described above, the abnormality detection information is output information of an angular velocity sensor configured to detect angular velocity data of a rotation of a rotation shaft in a valve unit in which an actuator rotates a rotation shaft to rotate a disc or ball of the valve.

According to the third aspect described above, in accordance with a rotation period of the disc or ball, the rotation period is divided into a rotation period in which the degree of abnormality of the valve can be estimated and a rotation period in which the degree of abnormality of the actuator can be estimated, making it possible to efficiently estimate the degrees of abnormality of both the valve and the actuator from a series of valve rotations.

In the information processing device according to a fourth aspect of the present invention, in any of the first to third aspects described above, the presentation information generation unit is configured to select one of the maintenance providers further selected in accordance with position information pertaining to the valve, position information pertaining to the maintenance providers, and recommendation levels set for the maintenance providers.

According to the fourth aspect described above, the user can select, from the presented providers, a provider that seems to be appropriate.

In the information processing device according to a fifth aspect of the present invention, in any of the first to fourth aspects described above, the information pertaining to the time related to the abnormality includes information pertaining to a recommended replacement time of the one of the plurality of elements in which the abnormality is detected.

According to the fifth aspect described above, the user can arrange a maintenance provider before the recommended replacement time and seamlessly receive the maintenance service.

In the information processing device according to a sixth aspect of the present invention, in any of the first to fifth aspects described above, the information pertaining to the time related to the abnormality includes information pertaining to a recommended replacement time of the one of the plurality of elements in which the abnormality is detected, the information pertaining to the recommended replacement time being selected based on information pertaining to recommended replacement times of all valves owned by the customer in an identical region.

According to the sixth aspect described above, the user can identify the recommended replacement times of all valves owned and seamlessly receive the maintenance service.

In the information processing device according to a seventh aspect of the present invention, in any of the first to sixth aspects described above, the information pertaining to the time related to the abnormality includes information pertaining to a recommended replacement time of the one of the plurality of elements in which the abnormality is detected, the information pertaining to the recommended replacement time being selected based on information pertaining to a time of periodic inspection of valves owned by the customer in an identical region or operation information pertaining to the customer.

According to the seventh aspect described above, the maintenance provider can appropriately acquire the information pertaining to the user.

In the information processing device according to an eighth aspect of the present invention, in any of the first to seventh aspects described above, the information pertaining to the time related to the abnormality includes an amount of change of a time indicated by the information presently generated relative to a time indicated by the information immediately preceding the information presently generated.

According to the eighth aspect described above, the information processing device is more effective from the viewpoint of outsourcing maintenance corresponding to a change in the recommended replacement time to a maintenance provider.

In the information processing device according to a ninth aspect of the present invention, in any of the first to eighth aspects described above, the information processing device further includes a maintenance capability information acquisition unit configured to acquire maintenance capability information pertaining to the maintenance providers, wherein the presentation information generation unit is configured to select one of the maintenance providers with further reference to the maintenance capability information acquired by the maintenance capability information acquisition unit.

According to the ninth aspect described above, the information processing device is more effective from the viewpoint of outsourcing maintenance to a maintenance provider capable of appropriately handling a change in the recommended replacement time.

In the information processing device according to a tenth aspect of the present invention, in any of the first to ninth aspects described above, the information pertaining to the time related to the abnormality includes an amount of change of a time indicated by the information presently generated relative to a time indicated by the information immediately preceding the information presently generated, and the information processing device further includes a maintenance order unit configured to place an order for maintenance with one of the maintenance providers selected by the presentation information generation unit in accordance with the amount of change of the time or outsourcing information from the customer.

According to the tenth aspect described above, the information processing device is even more effective from the viewpoint of being able to quickly and reliably respond to an unexpected abnormality while meeting the expectations of the user.

In the information processing device according to an eleventh aspect of the present invention, in the third aspect described above, the abnormality detection information acquisition unit is configured to acquire the abnormality detection information with further reference to second output information related to the valve unit other than the output information of the angular velocity sensor.

According to the eleventh aspect described above, the information processing device is more effective from the viewpoint of further increasing the reliability of the abnormality detection information and from the viewpoint of facilitating detection or estimation of the amount of change due to the abnormality or the degree of the abnormality, such as, for example, a leakage amount of fluid from a seal, or increasing the accuracy thereof.

An information processing system according to a twelfth aspect of the present invention includes: an abnormality detection information acquisition unit configured to acquire abnormality detection information including abnormality detection data related to each of a plurality of elements in a valve; a presentation unit configured to present presentation information for presenting, to a customer being a user of the valve, maintenance providers selected in accordance with one of the plurality of elements in which an abnormality is detected and information pertaining to a time; and a maintenance-related information provision unit configured to provide, to the selected maintenance providers, maintenance-related information related to the one of the plurality of elements in which the abnormality is detected and the time concerning the one of the plurality of elements in which the abnormality is detected.

According to the configuration of the twelfth aspect described above, it is possible to achieve the same effects as those of the information processing device of the first aspect.

An information processing method according to a thirteenth aspect of the present invention is an information processing method for supporting maintenance of a valve by generating information pertaining to the maintenance of the valve with reference to a signal configured to detect operation of the valve, the information processing method including: acquiring abnormality detection information including abnormality detection data related to each of a plurality of elements in the valve; generating presentation information for presenting, to a customer being a user of the valve, maintenance providers selected in accordance with one of the plurality of elements in which an abnormality is detected based on the abnormality detection information and information pertaining to a time related to the abnormality; and providing, to the selected maintenance providers, maintenance-related information related to the one of the plurality of elements in which the abnormality is detected and the information pertaining to the time related to the abnormality.

According to the configuration of the thirteenth aspect described above, it is possible to achieve the same effects as those of the information processing device of the first aspect.

An information processing program according to the fourteenth aspect of the present invention is an information processing program for causing a computer to function as the information processing device of the first to eleventh aspects, the information processing program being configured to cause the computer to function as the abnormality detection information acquisition unit, the presentation information generation unit, and the maintenance-related information provision unit.

According to the configuration of the fourteenth aspect described above, it is possible to achieve the same effects as those of the information processing device of the first to eleventh aspects.

The present invention is not limited to the embodiments described above, and various modifications can be made within the scope of the claims. Any embodiment based on a proper combination of technical means disclosed in different embodiments is also encompassed in the technical scope of the present invention.

### Reference Signs List

1 Sensor unit
2 Actuator
3 Valve
4 Control shaft (rotation shaft)
7 Gyro sensor
10 Sensor accommodation portion
100 Information processing system
101 Abnormality detection information acquisition unit
102 Presentation information generation unit
103 Maintenance-related information provision unit
104 Estimate acquisition unit
105 Maintenance order unit
106 Presentation information provision unit
201 User terminal device
202 Service provider terminal device
203 Maintenance provider terminal device
400 Server
404 Database
500 Information processing system
600 Gateway
A1 Ball seat
V1, V2, V3, V4 Valve unit

1. An information processing device comprising:
an abnormality detection information acquisition unit configured to acquire abnormality detection information including abnormality detection data related to each of a plurality of elements in pipeline equipment including a valve;
a presentation information generation unit configured to generate presentation information for presenting, to a customer being a user of the valve, maintenance providers selected in accordance with one of the plurality of elements in which an abnormality is detected based on the abnormality detection information and information pertaining to a time related to the abnormality; and
a maintenance-related information provision unit configured to provide, to the selected maintenance providers, maintenance-related information related to the one of the plurality of elements in which the abnormality is detected and the information pertaining to the time related to the abnormality.

2. The information processing device according to claim 1, further comprising:
an estimate acquisition unit configured to acquire an estimate from the maintenance providers having received the maintenance-related information;
a presentation information provision unit configured to provide, to the customer, the presentation information generated by the presentation information generation unit; and
a maintenance order unit configured to place an order for maintenance with one of the maintenance providers selected by the customer having received the presentation information.

3. The information processing device according to claim 1, wherein
the abnormality detection information is output information of an angular velocity sensor configured to detect angular velocity data of a rotation of a rotation shaft in a valve unit in which an actuator rotates the rotation shaft to rotate a disc or ball of the valve.

4. The information processing device according to claim wherein
the presentation information generation unit is configured to select one of the maintenance providers further selected in accordance with position information pertaining to the valve, position information pertaining to the maintenance providers, and recommendation levels set for the maintenance providers.

5. The information processing device according to claim 1, wherein
the information pertaining to the time related to the abnormality includes information pertaining to a recommended replacement time of the one of the plurality of elements in which the abnormality is detected.

6. The information processing device according to claim 1, wherein
the information pertaining to the time related to the abnormality includes information pertaining to a recommended replacement time of the one of the plurality of elements in which the abnormality is detected, the information pertaining to the recommended replacement time being selected based on information pertaining to recommended replacement times of all valves owned by the customer in an identical region.

7. The information processing device according to claim 1, wherein
the information pertaining to the time related to the abnormality includes information pertaining to a recommended replacement time of the one of the plurality of elements in which the abnormality is detected, the information pertaining to the recommended replacement time being selected based on information pertaining to a time of periodic inspection of valves owned by the customer in an identical region or operation information pertaining to the customer.

8. The information processing device according to claim 1, wherein
the information pertaining to the time related to the abnormality includes an amount of change of a time indicated by the information presently generated relative to a time indicated by the information immediately preceding the information presently generated.

9. The information processing device according to claim 1, further comprising:
a maintenance capability information acquisition unit configured to acquire maintenance capability information pertaining to the maintenance providers, wherein
the presentation information generation unit is configured to select one of the maintenance providers with further reference to the maintenance capability information acquired by the maintenance capability information acquisition unit.

10. The information processing device according to claim 1, wherein
the information pertaining to the time related to the abnormality includes an amount of change of a time indicated by the information presently generated relative to a time indicated by the information immediately preceding the information presently generated, and
the information processing device further comprises a maintenance order unit configured to place an order for maintenance with one of the maintenance providers selected by the presentation information generation unit in accordance with the amount of change of the time or outsourcing information from the customer.

11. The information processing device according to claim 3, wherein
the abnormality detection information acquisition unit is configured to acquire the abnormality detection information with further reference to second output information related to the valve unit other than the output information of the angular velocity sensor.

12. An information processing system comprising:
an abnormality detection information acquisition unit configured to acquire abnormality detection information including abnormality detection data related to each of a plurality of elements in a valve;
a presentation unit configured to present presentation information for presenting, to a customer being a user of the valve, maintenance providers selected in accordance with one of the plurality of elements in which an abnormality is detected and information pertaining to a time; and
a maintenance-related information provision unit configured to provide, to the selected maintenance providers, maintenance-related information related to the one of the plurality of elements in which the abnormality is detected and the time concerning the one of the plurality of elements in which the abnormality is detected.

13. An information processing method for supporting maintenance of a valve by generating information pertaining to the maintenance of the valve with reference to a signal configured to detect operation of the valve, the information processing method comprising:
acquiring abnormality detection information including abnormality detection data related to each of a plurality of elements in the valve;
generating presentation information for presenting, to a customer being a user of the valve, maintenance providers selected in accordance with one of the plurality of elements in which an abnormality is detected based on the abnormality detection information and information pertaining to a time related to the abnormality; and
providing, to the selected maintenance providers, maintenance-related information related to the one of the plurality of elements in which the abnormality is detected and the information pertaining to the time related to the abnormality.

14. An information processing program for causing a computer to function as the information processing device according to claim 1, the information processing program being configured to cause the computer to function as the abnormality detection information acquisition unit, the presentation information generation unit, and the maintenance-related information provision unit.

15. The information processing device according to claim 1, wherein
the abnormality detection information acquisition unit is configured to acquire the abnormality detection information including the abnormality detection data related to each of the plurality of elements in the valve.

16. The information processing device according to claim 1, wherein
the abnormality detection information acquisition unit is configured to acquire the abnormality detection information including the abnormality detection data related to each of the plurality of elements in a valve unit in which an actuator rotates a rotation shaft to rotate a disc or ball of the valve.

17. A device comprising:
a presentation information generation unit configured to generate presentation information for presenting, to a customer being a user of a valve, maintenance providers:
selected in accordance with one of a plurality of elements in pipeline equipment including the valve in which an abnormality is detected based on abnormality detection information including abnormality detection data related to each of the plurality of elements and information pertaining to a time related to the abnormality; and
provided with maintenance-related information related to the one of the plurality of elements in which the abnormality is detected and the information pertaining to the time related to the abnormality.

18. A device comprising:
a maintenance-related information provision unit configured to provide, to maintenance providers selected in accordance with one of a plurality of elements in pipeline equipment including a valve in which an abnormality is detected based on abnormality detection information including abnormality detection data for each of the plurality of elements and information pertaining to a time related to the abnormality, maintenance-related information related to the one of the plurality of elements in which the abnormality is detected and the information pertaining to the time related to the abnormality, the selected maintenance providers being present in presentation information for presenting, to a customer being a user of the valve, the selected maintenance providers.
